(19) United States
(12) Patent Application Publication
(10) Pub. No.: US 2013/0031415 A1
(43) Pub. Date: Jan. 31, 2013

(54) Entity Oriented Testing of Data Handling Systems

(71) Applicants: David Buckhurst, Manchester (GB); Michael T. Cartmell, Manchester (GB)

(72) Inventors: David Buckhurst, Manchester (GB); Michael T. Cartmell, Manchester (GB)

(73) Assignee: International Business Machines Corporation, Armonk, NY (US)

(21) Appl. No.: 13/189,805

(22) Filed: Jul. 25, 2011

(51) Int. Cl. G06F 11/36

(52) U.S. Cl. 714/38.1; 714/E11.207

(57) ABSTRACT

An apparatus and program product in which test components—here denominated entities—are handled by a test framework and wrapped in a common API (application programming interface) which provides command execution, file handling and inter-communication. The entities are interchangeable parameters to the test, hiding platform-specific code from the test developer and promoting code re-use. Retargettability is enabled by allowing specific systems—physical machines, for example—to be specified on a per test run basis, without changing generic test code.

### FIELD AND BACKGROUND OF INVENTION

Typical test frameworks, particularly unit-testing methods, revolve around source code, usually of a single application. The drawback of this approach is that it is difficult to test systems where multiple applications or hardware platforms are required to interact with each other. It is left to the test developer to write the code to start up and connect to each component, establish communication between them, and handle any errors. As a result, test development effort tends to be platform specific—a barrier to code re-use—and the test developer often ends up writing more auxiliary code than actual tests.

It is clearly desirable for tests to be retargettable, to be able to test different hardware platforms or components without changing the test itself. However, these components are often vastly disparate, perhaps requiring different connection methods or implementing different APIs.

### SUMMARY OF THE INVENTION

Entity-oriented testing as taught here facilitates a shift in the way tests are conceived and developed, moving away from single-platform, single-application tests and frameworks. Test components—entities—are handled by the test framework and wrapped in a common API (application programming interface) which provides command execution, file handling and inter-communication. They become interchangeable parameters to the test, hiding platform-specific code from the test developer and promoting code re-use. Retargettability is enabled by allowing specific entity instances—physical machines, for example—to be specified on a per test run basis, without changing the generic test code.

### BRIEF DESCRIPTION OF DRAWINGS

Some of the purposes of the invention having been stated, others will appear as the description proceeds, when taken in connection with the accompanying drawings, in which:

FIG. 1 is a schematic illustration of a digital data handling system;

FIG. 2 is schematic illustration of plurality of digital data handling systems associated for testing;

FIG. 3 is a flow chart representation of the assembly of an entity based test suite in accordance with the present description; and

FIG. 4 is a representation of a tangible computer readable storage medium having computer readable program code embodied therewith.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

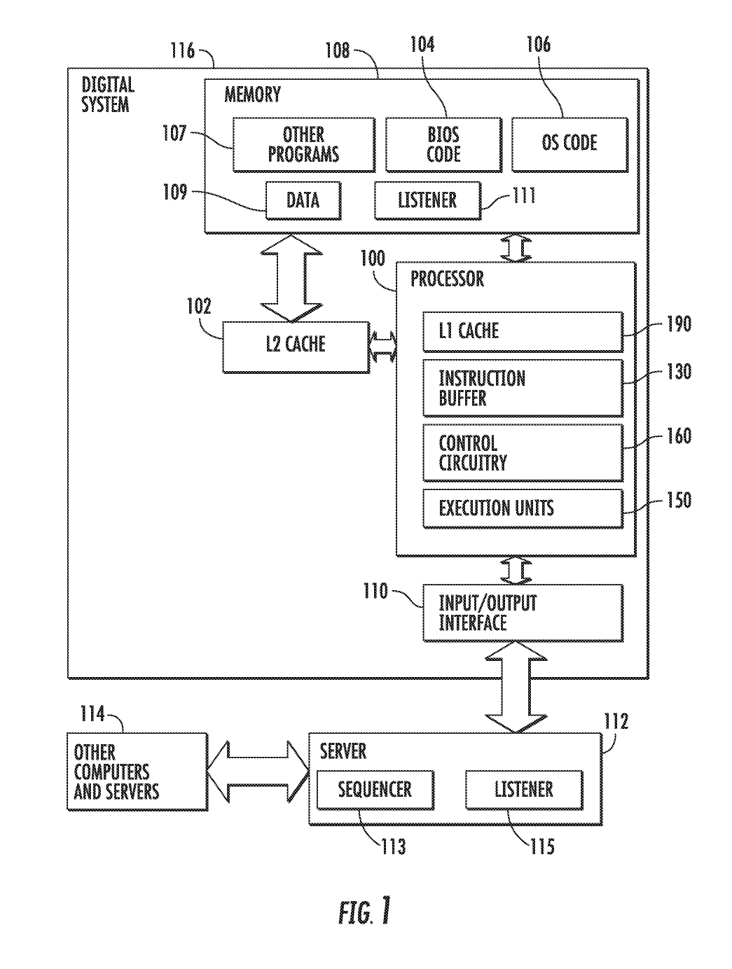

FIG. 1 shows a digital system 116 such as a computer or server implemented in a network according to one embodiment of the present invention. Digital system 116 comprises a processor 100 that can operate according to basic input-output system (BIOS) Code 104 and Operating System (OS) Code 106. The BIOS and OS code are stored in memory 108. The BIOS code is typically stored on Read-Only Memory (ROM) and the OS code is typically stored on the hard drive of computer system 116. Memory 108 also stores other programs for execution by processor 100 and stores data 109. Digital system 116 comprises a level 2 (L2) cache 102 located physically close to processor 100.

Processor 100 comprises an on-chip level one (L1) cache 190, an instruction buffer 130, control circuitry 160, and execution units 150. Level 1 cache 190 receives and stores instructions that are near to time of execution. Instruction buffer 130 forms an instruction queue and enables control over the order of instructions issued to the execution units. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions received from instruction buffer 130. Control circuitry 160 controls instruction buffer 130 and execution units 150. Control circuitry 160 also receives information relevant to control decisions from execution units 150. For example, control circuitry 160 is notified in the event of a data cache miss in the execution pipeline.

Digital system 116 also may include other components and subsystems not shown, such as: a SP, a Trusted Platform Module, memory controllers, random access memory (RAM), peripheral drivers, a system monitor, a keyboard, a color video monitor, one or more flexible diskette drives, one or more removable non-volatile media drives such as a fixed disk hard drive, CD and DVD drives, a pointing device such as a mouse, and a network interface adapter, etc. Digital systems 116 may include personal computers, workstations, servers, mainframe computers, notebook or laptop computers, desktop computers, or the like. Processor 100 also communicates with a server 112 by way of Input/Output Device 110. For example, I/O device 110 may comprise a network adapter. Server 112 may connect system 116 with other computers and servers 114. Thus, digital system 116 may be in a network of computers such as the Internet and/or a local intranet. Further, server 112 may control access to another memory 118 comprising tape drive storage, hard disk arrays, RAM, ROM, etc.

In one mode of operation of digital system 116, the L2 cache receives from memory 108 data and instructions expected to be processed in a pipeline of processor 100. L2 cache 102 is fast memory located physically close to processor 100 to achieve greater speed. The L2 cache receives from memory 108 the instructions for a plurality of instruction threads. Such instructions may include branch instructions. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Execution units 150 may comprise load/store units, integer Arithmetic/Logic Units, floating point Arithmetic/Logic Units, and Graphical Logic Units. Each of the units may be adapted to execute a specific set of instructions. Instructions can be submitted to different execution units for execution in parallel. In one embodiment, two execution units are employed simultaneously to execute certain instructions. Data processed by execution units 150 are storable in and accessible from integer register files and floating point register files (not shown). Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

Thus, the system of FIG. 1 may include a plurality of computers with processors and memory as just described, connected in a network served by a server. The server facilitates and coordinates communications between and among the computers in the network. Each computer has its own memory for storing its operating system, BIOS, and code for executing application programs, as well as files and data. The memory of a computer comprises Read-Only-Memory (ROM), cache memory implemented in DRAM and SRAM, a hard disk drive, CD drives and DVD drives. The server also has its own memory and may control access to other memory such as tape drives and hard disk arrays.

In an embodiment of the invention, a server 112 is in electrical communication with a plurality of computers to be tested. The server comprises a sequencer 113 that sends command messages to each computer under test to cause execution of certain steps and programs by a computer to verify correct operation. The sequencer 113 is implemented as a program in a directory that is executed by a processor of the server. Each command message from sequencer 113 specifies at least one environment and at least one command. Server 112 further comprises a listener 115. The system under test, for example, digital system 116, comprises a listener 111 that implements the environment specified in a received command message and executes a received command within the environment. A listener 111 is implemented as a program in a directory that is executed by processor 100.

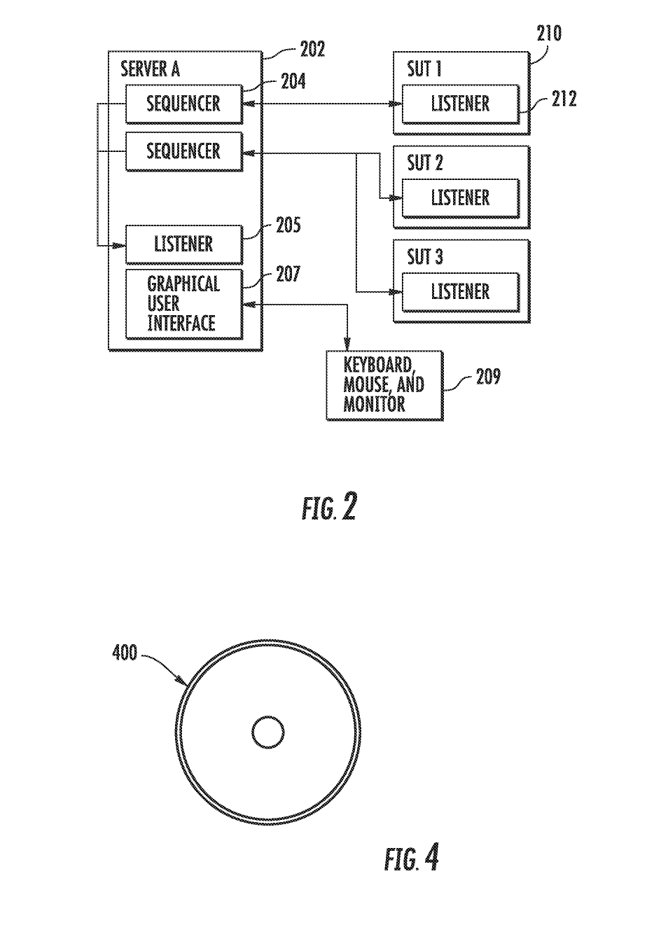

FIG. 2 shows an embodiment for testing a plurality of Systems Under Test (SUT). A controlling server A, 202, comprises one or more sequencers 204. Each sequencer is a master command scheduling program. A sequencer 204 originates command messages that are transmitted to the SUTs 210. A sequencer 204 of server 202 may also originate command messages that are transmitted to a listener of the server itself. Each server and each SUT may be a digital system such as digital system 116. Each server and each SUT includes a listener 205, 212. Each listener comprises a command queue (such as a message file directory or communication socket) for receiving commands from a sequencer.

In FIG. 2, a single sequencer may originate command messages to a plurality of different listeners. Each SUT has a listener that receives commands from one or more sequencers 204. In one embodiment, a single listener in an SUT 210 may receive commands from a plurality of sequencers from a plurality of servers. Thus, each of a plurality of servers may have one or more sequencers and a listener. A listener of a first server can receive command messages from a sequencer of a second server and vice versa. Thus, embodiments can provide one-to-many and many-to-many correspondence between sequencers and listeners.

One example of an implementation of the embodiment of FIG. 2 is in a computer manufacturing and test environment. In this example, each system under test (SUT) 210 is a computer such as digital system 116 in a manufacturing line to be tested before final packing and shipping. Applying the methods herein described, each of a plurality of computers is connected to a server. Dozens or even hundreds of computers may be connected and tested at one time. The connection may, for example, be by Ethernet cable through a network adapter installed on each computer under test. Alternatively, the server may be connected wirelessly to each computer using means known in the art. In a wireless environment, both the server and the computers under test are equipped with transmitter and receiver circuitry to both transmit and receive command messages and result messages.

There are three parts to implementing entity-oriented testing into a test framework:

(1) The interface for allowing entities to be passed as arguments to the test framework and instantiated internally;

(2) The platform-specific code for connecting and executing commands on these entities; and

(3) The common API for exposing entities to the test developer.

It is to be understood that, as here used, “entities” and “test framework” refer to program code written to be executed on the processor of a digital data handling system and to be stored in a storage element associated with such a system. “Entities” are smaller portions of code written with the intention of being used in a range of test routines. “Test frameworks” may be larger portions of code written with the intention of being used in test routines for specific systems or system configurations.

A key to understanding entities as discussed here is the distinctions among entity labels, entity types and entity identifiers. This separates a ‘type’ of entity—e.g. virtual machine, database, operating system—from a specific instance of it—e.g. a Vmware instance running locally, a remote MySQL server. The test developer is only interested in the entity label and the type. For example, a test may be written declaring that a ‘Unix shell’ entity is needed, knowing what commands will work on that type of entity, but not having to worry about what physical hardware or connection is used to interact with the entity.

On the other hand, the test framework is mostly concerned with the entity identifier and class, which it uses to construct an entity object and expose it to the test developer through its label.

It is contemplated that the list of classes which the test framework supports is finite, and there is an initial overhead in implementing the platform-specific code in the test framework before tests can be written to use that class of entity. It is a trade-off, however; the up-front work to add the support pays off during test development, in vastly reduced lines of code and increased maintainability.

Every class of entity in the test framework implements a common interface, since no knowledge of the underlying API is necessary. In the simplest implementation, the test framework just needs to know how to set up or connect to the entity (if required), and how to execute commands on it. Therefore, each class of entity has a setup method and an execute method, which handles the detail of how to execute the command and returns the result in a standard format. Basic error handling can be performed in the test framework.

As an example, imagine a simple client-server test: a UNIX server must set some environment variables and issue a start command to a MySQL database. A Windows client then connects to it, runs a simple query, and checks that the result is correct.

There could be three entities here:

The UNIX server. For the purposes of this example, the class is UNIX and the label server.

The MySQL database. Class mysql, label database.

The Windows client. Class Windows, label client.

It is contemplated that the test framework knows how to connect to and issue commands to each of these types of entity. The first thing the test developer must do is declare the entity labels they to be used in the test, along with the class for each one. This could look like (in a test configuration file):

```
entities:
      server:
            class: UNIX
      database:
            class: MySQL
      client:
            class: Windows
```

The test developer uses these labels to retrieve the corresponding entity objects, which will be instantiated by the test framework in each test run. The pseudocode for the test might look something like:

s = getEntity(‘server’)
db = getEntity(‘database’)
c = getEntity(‘client’)
s.execute(‘set debug=1’)
db.execute(‘start’)
c.connect_to(db)
result = c.execute(‘select * from users’)
if (result.status == OK) test passed

Note how the entities are retrieved in the test from the test framework using only their label. The details of how the framework connects to each entity is hidden from the test developer. Every entity implements the execute method to the same interface. For the example, it is assumed that the return value of a call to execute has a ‘status’ property in each case.

The only remaining step is to run the test, providing an instance of each entity to be used for testing. This can be as simple as providing a mapping of label=>identifier; as long as the identifier is in a format understood by the test framework, this is sufficient to construct entity objects. For example, the identifier for client and server could be the hostnames or IP addresses assigned to those machines. The identifier for database could be the network port that the database is listening on.

As an example command to run the test framework:
$ runTests <test name>client=10.0.0.2 server=10.0.0.1 database=localhost:3306

During initialization, the test framework will construct the entity objects internally, using the platform-specific code that has been implemented in the test framework, retrieving the test components from storage and transforming the retrieved test components into a runtime instance operable within the computer program test execution framework. The test developer can then retrieve these objects using only the label, as demonstrated by getEntity in the pseudocode above, and begin to execute commands on them in the test.

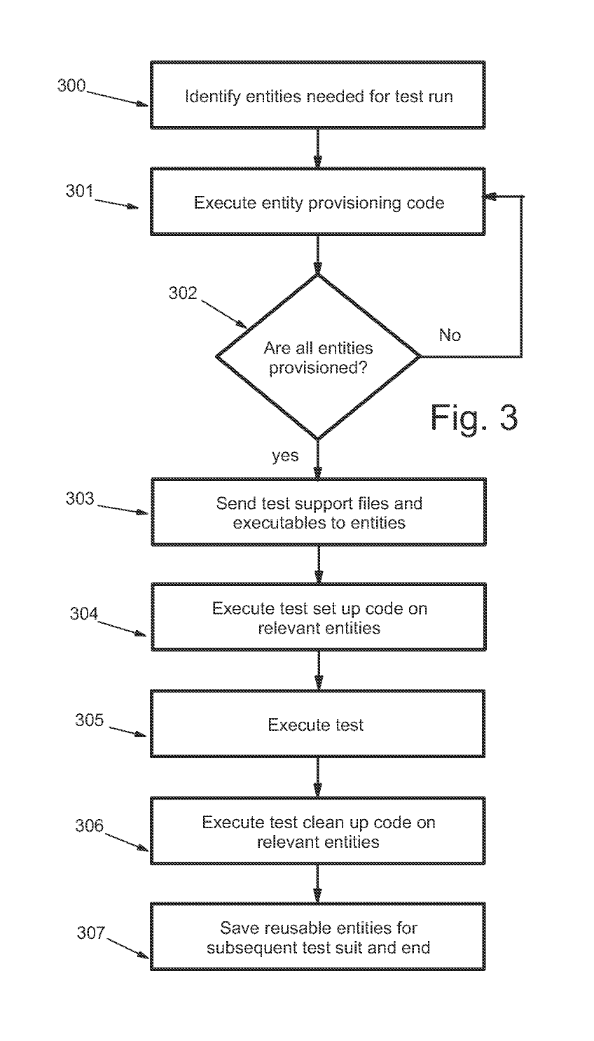

The flowchart of FIG. 3 illustrates exemplary steps which may be implemented in accordance with this invention. There, the initial step shown is the identification of the entities needed for a particular test run at 300. Following such identification, entity provisioning code executes (301) and a check is made that all entities have been provisioned (302). When ready to proceed, test support files and executable are sent to the entities (303) and test set up code is executed (304) to prepare the test framework. When prepared, the intended test will be executed (305). Having obtained results, test clean up code executes (306) to prepare the reusable entities for storage for subsequent reuse (307) and the sequence ends.

One or more aspects of the present invention can be included in an article of manufacture (e.g., one or more computer program products) having, for instance, tangible computer usable media, indicated at 400 in FIG. 4. The media has embodied therein, for instance, computer readable program code for providing and facilitating the capabilities of the present invention. The article of manufacture can be included as a part of a computer system or sold separately. Machine readable storage mediums may include fixed hard drives, optical discs such as the disc 400, magnetic tapes, semiconductor memories such as read only memories (ROMs), programmable memories (PROMs of various types), flash memory, etc. The article containing this computer readable code is utilized by executing the code directly from the storage device, or by copying the code from one storage device to another storage device, or by transmitting the code on a network for remote execution.

In the drawings and specifications there has been set forth a preferred embodiment of the invention and, although specific terms are used, the description thus given uses terminology in a generic and descriptive sense only and not for purposes of limitation.

1. (canceled)

2. (canceled)

3. (canceled)

4. (canceled)

5. (canceled)

6. (canceled)

7. (canceled)

8. An apparatus comprising:
a digital data handling system having a processor and a storage element;
a computer program test execution framework for a computer system and a test component to be instantiated in the test execution framework stored in said storage element;
said processor retrieving from said storage element said computer program test execution framework and said test component; and
said processor transforming said test component into a runtime instance operable within said computer program test execution framework.

9. An apparatus according to claim 8 wherein said test framework is specific to a particular computer system platform.

10. An apparatus according to claim 8 wherein said test framework has an interface facilitating reception and instantiation of test components.

11. An apparatus according to claim 8 wherein said specified test component is one of a plurality of stored test components which share a common application program interface.

12. An apparatus according to claim 11 wherein each of said plurality of stored test components is tagged with an entity label, an entity class and an entity identifier.

13. An apparatus according to claim 12 wherein a user specifying the configuration of a test run indicates to the test framework the entity label and class to be retrieved and instantiated for the run.

14. A computer program product for supporting the testing of computer systems, the computer program product comprising:
a computer readable storage medium having computer readable program code embodied therewith, the computer readable program code configured to:
specify a computer program test execution framework for a computer system and a test component to be instantiated in the test execution framework;
retrieve a specified test component from a storage; and
transform the retrieved test component into a runtime instance operable within the computer program test execution framework.

15. A program product according to claim 14 wherein the test framework is specific to a particular computer system platform.

16. A program product according to claim 14 wherein the test framework has an interface facilitating reception and instantiation of test components.

17. A program product according to claim 14 wherein the specified test component is one of a plurality of stored test components which share a common application program interface.

18. A program product according to claim 17 wherein each of the plurality of stored test components is tagged with an entity label, an entity class and an entity identifier.

19. A program product according to claim 18 wherein a user specifying the configuration of a test run indicates to the test framework the entity label and class to be retrieved and instantiated for the run.

20. A program product according to claim 14 wherein said program code is configured to execute the test execution framework and runtime instance of a retrieved test component.
